(19) United States
(12) Patent Application Publication
(10) Pub. No.: US 2026/0169443 A1
(43) Pub. Date: Jun. 18, 2026

(54) REGULATING SYSTEM FOR A HOROLOGY MOVEMENT COMPRISING A DEVICE FOR STOPPING AN OSCILLATOR

(71) Applicant: Montres Breguet S.A., L'Abbaye (CH)

(72) Inventors: Jérôme MACE, Le Pont (CH); Jean-Philippe ROCHAT, Les Bioux (CH)

(73) Assignee: Montres Breguet S.A., L'Abbaye (CH)

(21) Appl. No.: 19/375,997

(22) Filed: Oct. 31, 2025

(30) Foreign Application Priority Data
Dec. 13, 2024 (EP) 24219947.9

(51) Int. Cl. G04F 7/08; G04B 27/00

(52) U.S. Cl. CPC G04F 7/0842; G04B 27/004

(57) ABSTRACT

A regulating system (200) including a stop device (150) including a retaining organ (151), secured to the balance (121), configured to engage with a stop click (155) mounted to rotate freely at one end of a stop lever (152), the stop lever being mobile between an inactive position allowing free oscillation of the mechanical oscillator (120) and an activated position in which the stop click is on the path of the retaining organ. The stop click is configured so that, when the stop lever is in the activated position, the stop click allows the retaining organ to move in the direction of rotation (S1, S2) of the current vibration of the balance, when the stop device is activated, to lock the rotation in the reverse direction of rotation of the balance in the next vibration, the stop click forming a stop to the movement of the retaining organ.

### CROSS-REFERENCE TO RELATED APPLICATIONS

This application claims priority to European Patent Application No. 24219947.9 filed December 13, 2024, the entire contents of which are incorporated herein by reference.

### TECHNICAL FIELD OF THE INVENTION

The invention relates to the field of regulating systems for horology movements.

The invention relates more specifically to stop devices used to stop a mechanical oscillator fitted to such regulating systems, in particular during a time-setting operation or when the barrel is at a minimum winding level.

The invention also relates to a horology movement comprising a regulating system and to a timepiece comprising such a horology movement.

### TECHNOLOGICAL BACKGROUND

Conventionally, a regulating system comprises a mechanical oscillator comprising a balance and a resilient organ.

In high-end timepieces, the regulating system can also comprise a device for stopping the mechanical oscillator.

Such an oscillator stop device, also known as a “stop-balance,” is used to stop the oscillation of the balance when setting the time on the timepiece using the control stem, thereby immobilising the position of the seconds hand. Such a stop device enables the horology movement to be restarted at a precise moment.

Conventional mechanical oscillator stop devices, typically used for balances, comprise a stop lever controlled by the position of the control stem on the timepiece or controlled by pressing a button. Conventionally, the end of the lever bears against the outer peripheral face of the felloe on the balance or against the balance staff.

Another solution, as described in US patent 2,212,535, proposes to use several balance screws, distributed over the felloe and pointing outwards, as stops to engage with a peg provided at the end of a stop lever when the latter is actuated by a stop control.

The drawback of such stop devices is that the angular stop position of the mechanical oscillator is random. This means that there is a risk that the balance will be stopped in a certain position in which the resilient organ has little or no potential energy, preventing the oscillator from restarting. Moreover, if the balance is stopped while the resilient organ has non-zero potential energy, this energy will be variable and different at each stop depending on the angular position of the balance when it is stopped. As a result, the amplitude of the balance when it restarts will be variable and the rate will not be accurate.

One solution has been provided in US patent 3,733,805, which consists of providing at least one serrated portion around the edge of the balance felloe, consisting of a series of concave indentations alternating with convex protuberances. The serrated portion extends over an angular sector of 30° to 90°. However, even if this solution makes it possible to keep the balance from stopping in the position in which the resilient organ has zero potential energy due to the position of the serrated portion, the angular stop position of the balance is still random on this portion. In this case, the amplitude of the balance when it restarts will vary, resulting in inaccuracy when running is resumed, which is unacceptable in timepieces that are supposed to measure time with great precision.

Another solution has been provided in application EP 2221678, which consists of providing a heart-shaped cam, secured to a balance staff associated with a balance spring, and a lever in the form of a hammer which, when actuated, bears on the heart piece and locks the balance. The shape of the heart piece is determined so as to move the balance to a predetermined angular stop position in which the balance spring has non-zero potential energy. However, this solution also has drawbacks, as further stress is applied to the balance and to the balance spring when the balance is returned to the angular stop position. Furthermore, using a heart piece for stopwork can drive the oscillator in the opposite direction to its natural cycle.

There is therefore a need to improve regulating systems for horology movements, particularly stop devices.

### SUMMARY OF THE INVENTION

The present invention aims to remedy at least one of the aforementioned drawbacks by providing a regulating system comprising a device for stopping a mechanical oscillator, ensuring that the mechanical oscillator stops in a predetermined angular position without interacting with the balance staff and ensuring that it resumes running quickly and accurately.

The present invention also aims to provide a device for stopping a mechanical oscillator enabling the balance to be stopped in an angular position in which the spring has non-zero potential energy so that the mechanical oscillator automatically and immediately restarts.

To this end, the present invention relates to a regulating system for a horology movement comprising:

a mechanical oscillator, oscillating around an axis of oscillation A1 comprising a balance coupled to a spring, each oscillation of said mechanical oscillator consisting of two successive vibrations characterised by the rotation of the balance in two successive and opposite directions of rotation;

a stop device on the mechanical oscillator configured to lock the balance in a predetermined angular position for each of the two vibrations of the mechanical oscillator, in which the spring has non-zero potential energy.

According to the invention, the stop device comprises a retaining organ, secured to the balance, configured to engage with a stop click mounted so as to rotate freely at one end of a stop lever, said stop lever being mobile between an inactive position allowing free oscillation of the mechanical oscillator and an activated position in which the stop click is on the path of the retaining organ. In addition, the stop click is configured so that when the stop lever is in the activated position, it allows the retaining organ to move in the direction of rotation of the current vibration of the balance when the stop device is activated and locks the rotation in the reverse direction of rotation of the balance during the next vibration, said stop click forming a stop to the movement of the retaining organ.

Preferentially, the stop click is kept in an equilibrium position by a stop spring.

Preferentially, the stop click comprises a first beak formed by the junction of a first sliding surface and of a first stop surface, the first sliding surface being configured so as to ensure, on contact with the retaining organ, that the stop click is rotated, in the first direction of rotation of the balance, against the stop spring, so as to allow the movement of the retaining organ in a first direction of rotation of the balance, the first stop surface being configured to form a stop to the movement of the retaining organ and to lock the rotation of the balance in a second direction of rotation, opposite to the first direction of rotation of the balance.

Preferentially, the stop click comprises a second beak formed by the junction of a second sliding surface and of a second stop surface, the second sliding surface being configured so as to ensure, on contact with the retaining organ, that the stop click is rotated, in the second direction of rotation of the balance, against the stop spring, so as to allow the movement of the retaining organ in the second direction of rotation of the balance, the second stop surface being configured to form a stop to the movement of the retaining organ and to lock the rotation of the balance in the first direction of rotation.

Preferentially, the first beak and the second beak are positioned opposite and symmetrical to a plane running through the axis of rotation of the stop click and through the axis of oscillation of the mechanical oscillator.

Preferentially, the stop click has a C-shape in which the two ends of the C carry the first beak and the second beak.

Preferentially, the stop device is configured to lock the balance in an angular position with an angular lag comprised between 120° and 180° (in the clockwise or counterclockwise direction), preferentially comprised between 120° and 180°, relative to a locked position P₀ of the balance. The angular position P₀ of the balance corresponds to the position of the balance in which the spring is not stressed, that is, neither contracted nor extended. In other words, in this angular locked position P₀, the balance has zero potential energy. When the balance is in its locked position P₀, the retaining organ is aligned with the escapement line.

Preferentially, the balance comprises a felloe attached to a central part by arms, the retaining organ being positioned at the level of one of the arms or at the level of the felloe.

Preferentially, the retaining organ is made of the same material as the balance or is formed by a pin, a peg, or a stud driven into the balance.

The invention also relates to a horology movement comprising a regulating system according to the invention.

Preferentially, the horology movement comprises a direct impulse escapement associated with the regulating system according to the invention.

Preferentially, the direct impulse escapement is a natural escapement.

### BRIEF DESCRIPTION OF THE FIGURES

The purposes, advantages and characteristics of the present invention will become apparent from the detailed description below in reference to the following figures:

FIG. 1 illustrates a schematic top view of an exemplary embodiment of a regulating system according to the invention comprising a stop device; in particular, FIG. 1 illustrates the regulating system when the stop device is in the non-activated position;

FIG. 2 illustrates a schematic top view of the regulating system when the stop device is in the activated position;

FIGS. 3 to 6 illustrate different states of the balance and of the stop device when the stop device is activated, bringing the balance to a halt;

FIG. 7 is a flow chart of a horology movement incorporating a regulating system according to the invention illustrated in FIGS. 1 to 6.

In all of the figures, common elements have the same reference numbers unless otherwise specified.

### DETAILED DESCRIPTION OF THE INVENTION

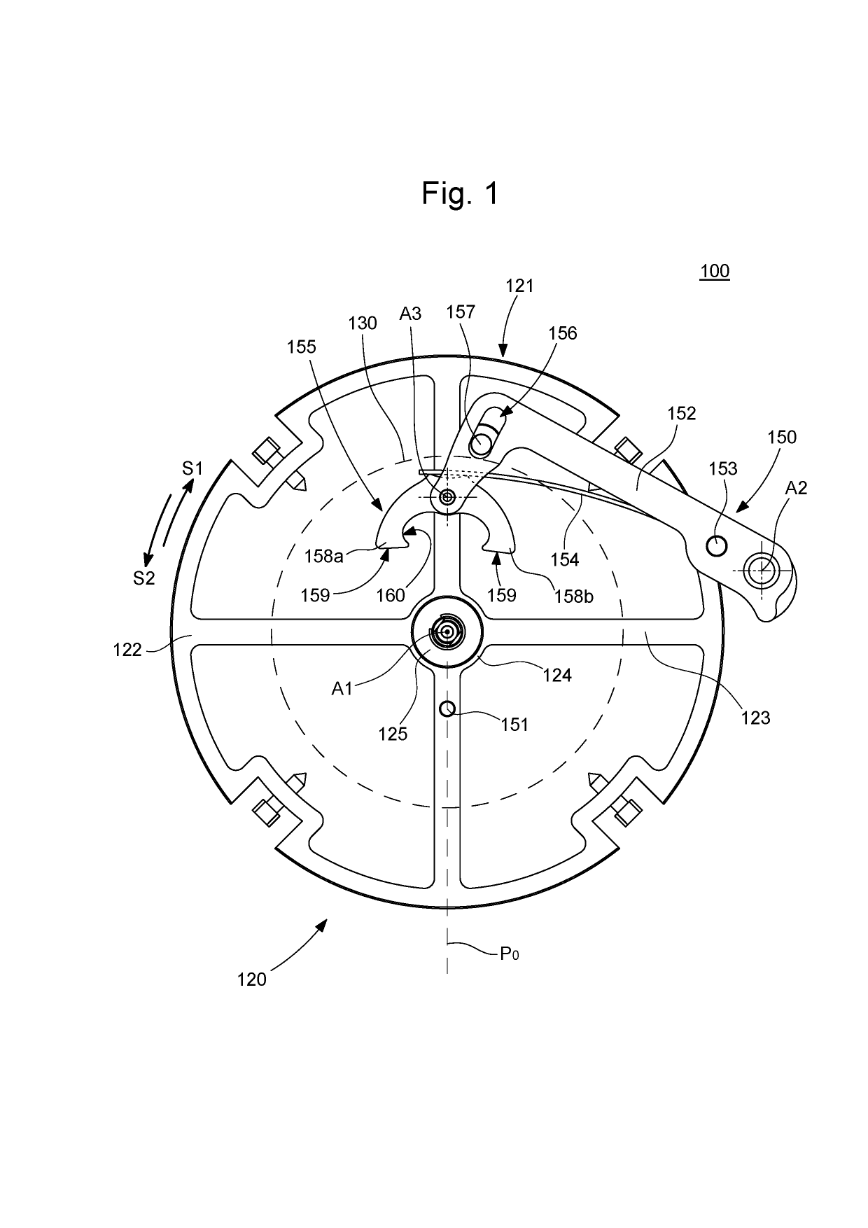

FIGS. 1 to 6 illustrate, in a schematic top view, different states of an exemplary embodiment of a regulating system 100 for a horology movement 200 according to the invention comprising a stop device 10.

In particular, FIG. 1 illustrates the regulating system 100 in operation when the stop device 150 is in an inactive position.

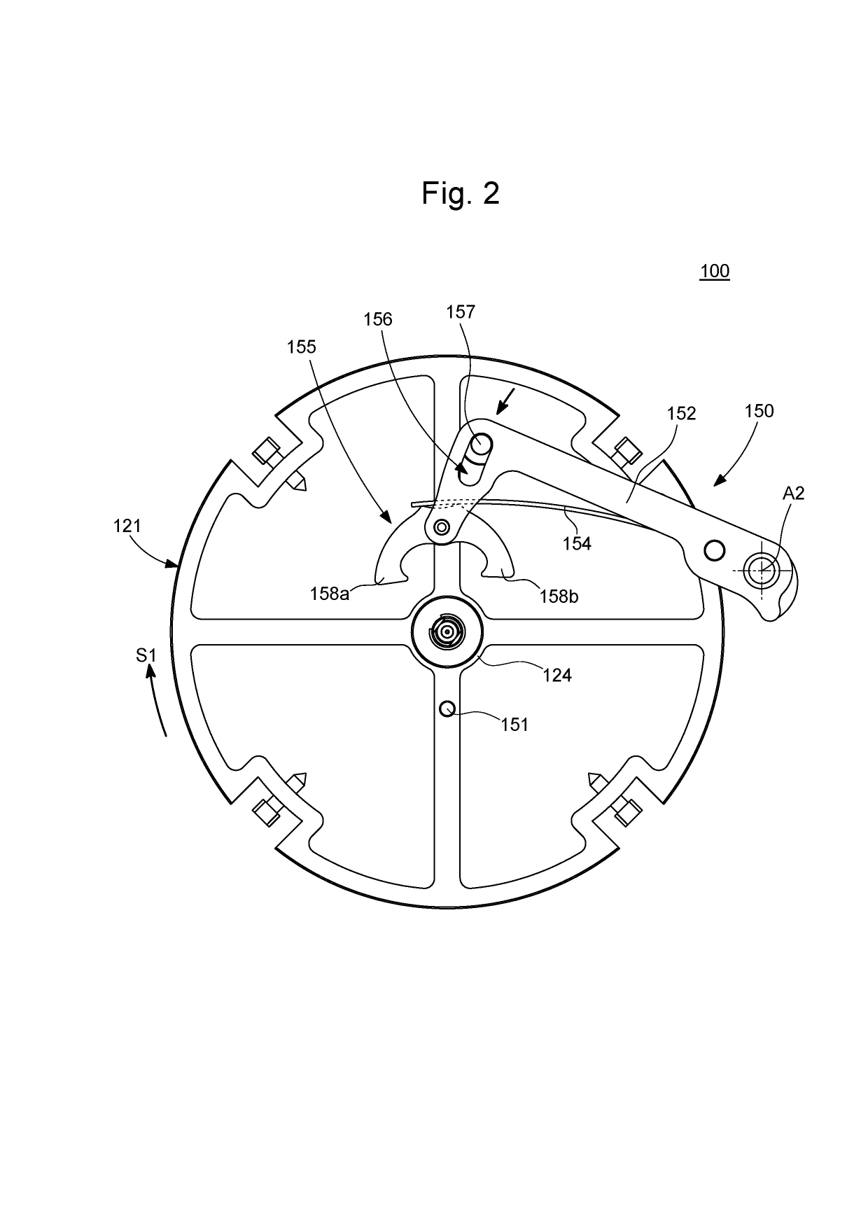

In particular, FIG. 2 illustrates the regulating system 100 when the stop device 150 is activated, when it is in an activated position.

The regulating system 100 comprises a mechanical oscillator 120 oscillating around an axis of oscillation A1.

The mechanical oscillator 120 comprises a balance 121 provided with a generally circular felloe 122 attached to a central part 124 by the balance arms 123. The central part 124 is secured to an arbor of the balance staff 125, extending along the axis of oscillation A1.

Conventionally, the balance 121 is coupled to a spring 130, for example a balance spring, schematically represented by a dotted circle in FIG. 1 for the sake of simplicity. The balance spring 130 is conventionally coupled to the balance 121.

Each oscillation of said mechanical oscillator 120 is defined by the succession of two vibrations characterised by the rotation of the balance 121 in a first direction of rotation S1 and then in a second, opposite direction of rotation S2.

With the first oscillation vibration, the balance spring 130 on the mechanical oscillator 120 will, for example, contract until it reaches maximum contraction in a first angular position at the end of the oscillation of the balance 121, and with the next vibration, the balance spring 130 on the mechanical oscillator 120 will relax and then deploy until it reaches maximum relaxation in a second angular position at the end of the oscillation of the balance 121, and so on. Obviously, the angular positions at the end of the oscillation of the balance 121 depend on the amount of available energy in the barrel.

With each vibration of the mechanical oscillator 120, the balance 121 moves through an angular position in which the potential energy of the balance spring 130 is zero. In this particular angular position of the balance 121, the balance spring 130 is completely relaxed and exhibits neither expansion nor contraction. This particular angular position is referred to herein as the locked position P₀.

The regulating system 100 according to the invention comprises a stop device 150 enabling the position of the mechanical oscillator 120, and more specifically the balance 121, to be locked in a predetermined angular position Pbloc, Pbloc', in response to a user command.

The stop device 150 advantageously locks the balance 121 in a predetermined angular position in which the balance spring 130 has non-zero potential energy, a position in which the restart of the balance 121 is ensured.

For example, the stop device 150 according to the invention enables the balance 121 to be locked in a first predetermined angular position Pbloc in which the balance spring 130 is contracted and has sufficient energy to ensure autonomous start-up of the regulating system 100.

According to an alternative embodiment, the stop device 150 according to the invention enables the balance 121 to be locked in a second predetermined angular position Pbloc’ in which the balance spring 130 is deployed and has sufficient energy to ensure autonomous start-up of the regulating system 100.

Preferentially, the stop device 150 according to the invention is configured to lock the balance 121 both in a first predetermined angular position Pbloc in which the balance spring 130 is contracted and has sufficient energy to ensure that the regulating system 100 starts automatically, and in a second predetermined angular position Pbloc' in which the balance spring 130 is deployed and has sufficient energy to ensure that the regulating system 100 starts autonomously, depending on the vibration of the mechanical oscillator 120 when the stop device 150 is activated.

Thus, the stop device 150 according to the invention advantageously enables the balance 121 to be locked in a predetermined angular position, regardless of the vibration of the oscillation when the stop device 150 is activated.

Preferentially, the stop device 150 is configured to lock the balance 121 in a predetermined angular position Pbloc, Pbloc' with an angular lag comprised between 120° and 180° relative to an angular lock position P₀ of the balance 121.

Preferentially, the stop device 150 is configured to lock the balance 121 in a predetermined angular position Pbloc, Pbloc' with an angular lag comprised between 130° and 180° relative to an angular lock position P₀ of the balance 121.

Preferentially, the stop device 150 is configured to lock the balance 121 in a predetermined angular position Pbloc, Pbloc' with an angular lag comprised between 140° and 180° relative to an angular lock position P₀ of the balance 121.

Preferentially, the stop device 150 is configured to lock the balance 121 in a predetermined angular position Pbloc, Pbloc' with an angular lag comprised between 150° and 180° relative to an angular lock position P₀ of the balance 121.

With this invention, when the horology movement 200 is restarted, the balance 121 will be able to start again with a known amplitude that is constant over time, thus ensuring high precision of the rate of the horology movement 200. Such a stop device 150 is particularly suitable for use with any type of oscillator and regulator.

The stop device 150 comprises a retaining organ 151 secured to the balance 121.

The retaining organ 151 extends in a direction parallel to the axis of oscillation A1 of the mechanical oscillator 120, such that it protrudes relative to an upper face or a lower face on the balance 121.

Preferentially, the retaining organ 151 is arranged on the face on the balance which is opposite to the balance spring 130.

The retaining organ 151 is, for example, a pin, a peg, a stud, a stop, etc., mounted on the upper or lower face on the balance 121. The retaining organ 151 can also be made of the same material as the balance 121.

Preferentially, the retaining organ 151 is arranged at the level of the felloe 122 or at the level of one of the arms of the balance 123. The retaining organ 151 has a predetermined position relative to the escapement line that corresponds to the straight line running from the axis of rotation of the arbor of the balance staff 125 to the axis of rotation of the escapement wheel arbor (not shown). Advantageously, the retaining organ 151 is positioned on the balance so as to be aligned with the escapement line when the balance 121 is in its locked angular position P₀.

The stop device 150 also comprises a stop lever 152, or stop rocker, controlled directly or indirectly by a stop control actuated on demand by the user or by a train on the horology movement. The stop control can be actuated, for example, by a control arbor, a winding stem or a button.

The stop lever 152 is rotationally mobile around an axis of rotation A2 between an inactive position (illustrated in FIG. 1) in which the mechanical oscillator 120 oscillates freely and an activated position (illustrated in FIG. 2). The various positions of the stop lever 152 are indexed, for example, by a peg 157 or a stud, which is fixed, for example, secured to a plate or to a bar on the horology movement 200, acting as a stop with the ends of an opening 156 provided in the body of the stop lever 152. Of course, a reverse arrangement of a peg secured to the stop lever 152 engaging with an opening formed in a plate or bar on the horology movement is also possible without departing from the context of the invention.

The stop lever 152 is coupled, at the end opposite the axis of rotation A2, to a stop click 155 configured to engage with the retaining organ 151 on the balance 121 when the stop device 150 is activated. When the stop lever 152 is in the activated position, the stop click 155 is positioned on the circular path of the retaining organ 151.

The stop click 155 is mounted so as to rotate freely on the end of the stop lever 152 around an axis of rotation A3 and engages with a click spring 154 tending to return the stop click 155 to a position of equilibrium when it is not acted upon.

The click spring 154 bears against a peg 153 mounted on the stop lever 152 and against the back of the stop click 155.

In a first inactive position of the stop lever 152, that is, when the stop device 150 is not actuated, the stop click 155 is not positioned on the path of the retaining organ 151, such that the balance 121 can oscillate freely under the impulse of the balance spring 130. This first free oscillation position of the mechanical oscillator 120 is illustrated in FIG. 1.

When the stop control is actuated, the stop control directly or indirectly drives the stop lever 152, which pivots around the axis of rotation A2 in its activated position as shown in FIG. 2, moving the stop click 155 closer to the arbor of the balance staff 125 and such that the stop click 155 is positioned on the path of the retaining organ 151. With the stop lever 152 in this activated position, the peg 157 acts as a stop with the upper end of the opening 156.

The stop click 155 comprises at least one beak 158a, 158b configured to engage with the retaining organ 151 secured to the balance 121 and to lock the rotation of the balance 151 in a predetermined angular position by engaging with the retaining organ 151.

Preferentially, the stop click 155 has a C-shape and comprises two opposite beaks 158a, 158b arranged symmetrically relative to a plane running through the axis of rotation A3 of the stop click 155 and through the axis of oscillation A1 of the mechanical oscillator 120. Preferentially, the two beaks 158a, 158b are arranged at the ends of the C. The two beaks 158a, 158b

advantageously enable the balance 121 to be locked in two predetermined angular positions Pbloc, Pbloc', one position for each vibration component on the mechanical oscillator 120.

More specifically, each beak 158a, 158b has a profile configured to allow the retaining organ 151 to move in a particular direction of rotation of the balance 121, and to lock the retaining organ 151 in the reverse direction of rotation of the balance 121.

Each beak 158a, 158b is formed by the junction of a sliding surface 159 and a stop surface 160, the two surfaces 159, 160 joining at an end part.

The sliding surface 159 is configured to engage with the retaining organ 151 without locking when the balance 121 rotates in a predetermined direction of rotation. The sliding surface 159 is oriented so that the stop click 155 can be rotated around its axis of rotation A3 under the action of the retaining organ 151, moving against the stress of the click spring 154.

The stop surface 160 comprises at least one portion oriented substantially perpendicular to the path of the retaining member 151 in a second direction of rotation of the balance 121, opposite to the direction of rotation described above, to form a stop to the movement of the retaining member 151 and to lock the rotation of the balance 121.

For example, the first beak 158a is configured to allow the retaining organ 151 to move in the first direction of rotation S1 (clockwise) of the balance 121, and to lock the retaining organ 151 in the second direction of rotation S1 (counterclockwise) of the balance.

For example, the second beak 158b is configured to allow the retaining organ 151 to move in the second direction of rotation S2 (counterclockwise) of the balance 121, and to lock the retaining organ 151 in the first direction of rotation S1 (clockwise) of the balance.

The stop click 155 therefore functions in a similar way to a double click.

When the stop control is actuated, two scenarios can occur depending on the oscillation vibration mode of the mechanical oscillator 120.

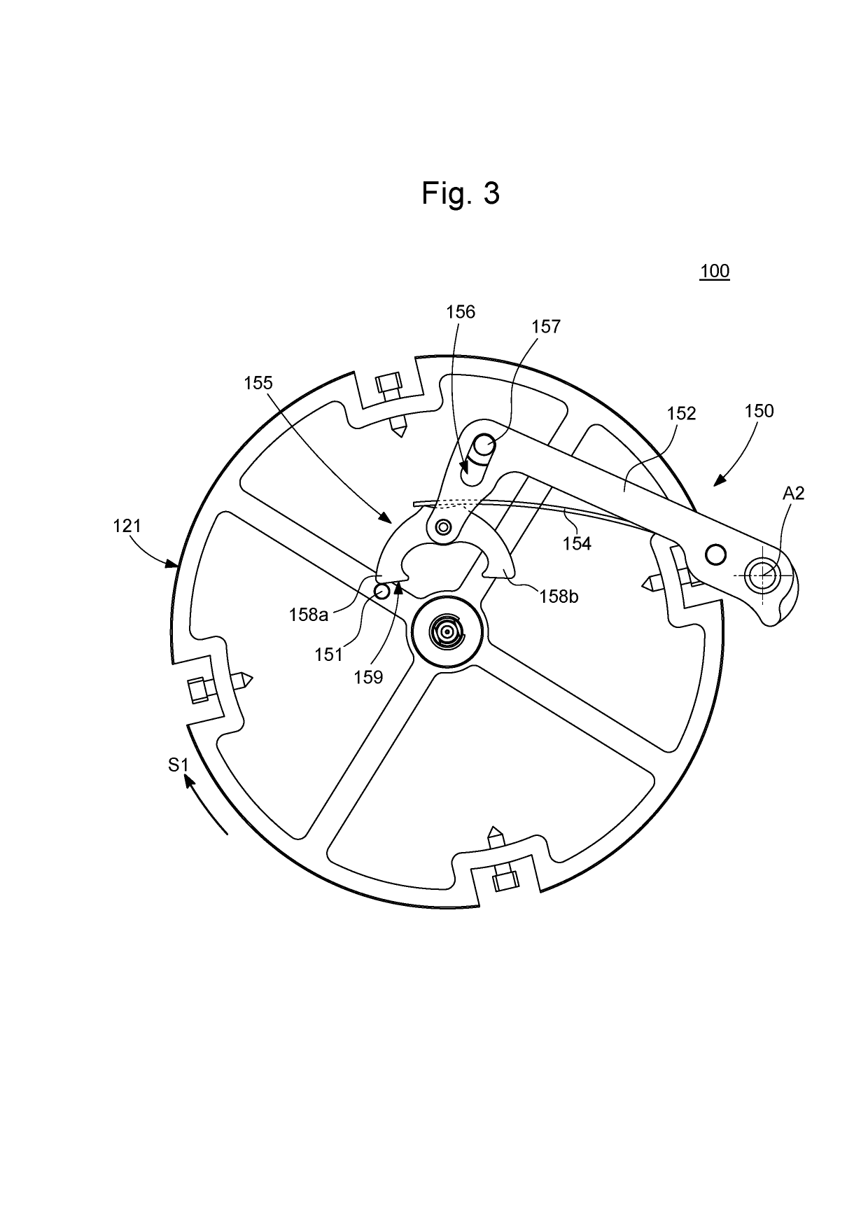

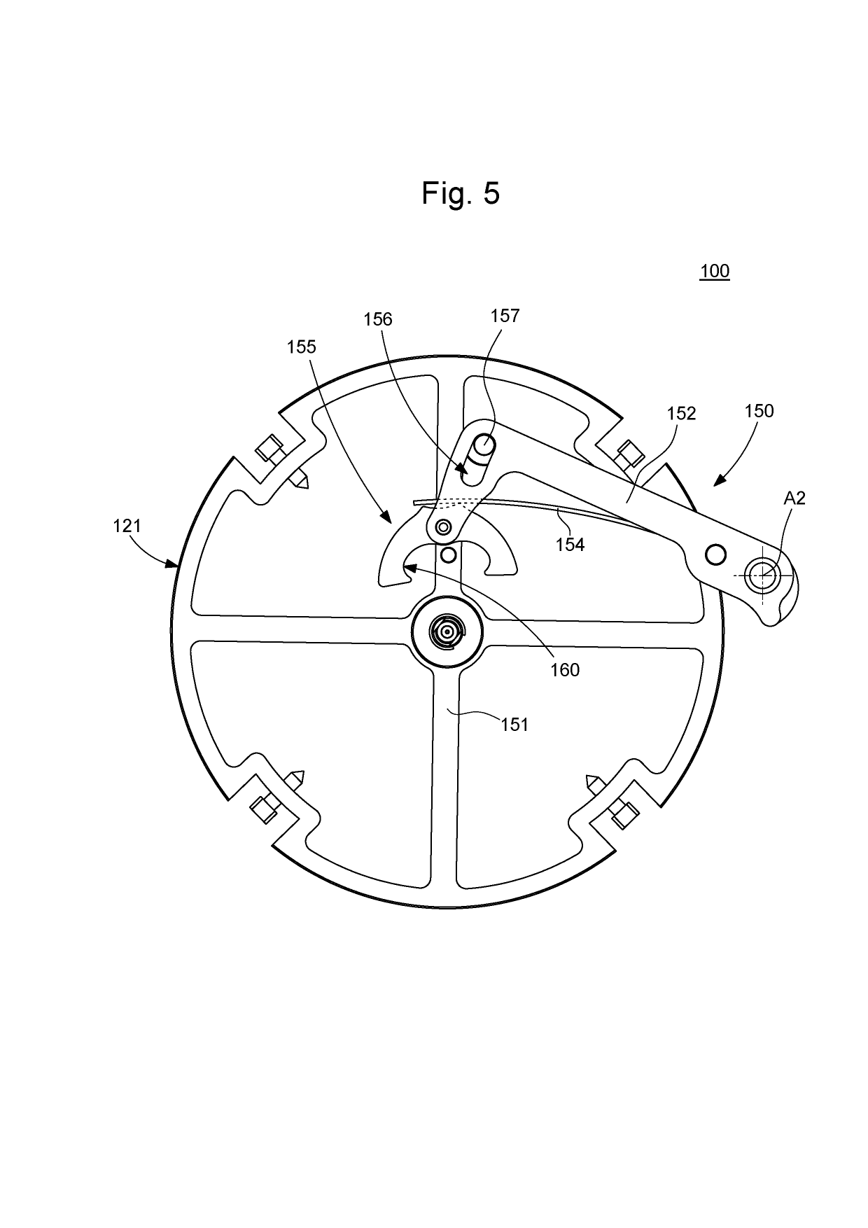

If the balance 121 is turning in the clockwise direction S1 when the stop control is activated, as shown in FIG. 2, the balance 121 will continue its rotation around its axis of oscillation A1 in the clockwise direction S1 until it reaches a first angular position at the end of the oscillation (illustrated in FIG. 5) before starting again in the counterclockwise direction S2 for the next oscillation. As this oscillation vibration is occurring, while the stop click 155 is on the path of the retaining organ 151, it will come into contact with the sliding surface 159, at a distal portion of the end part of the first beak 158a. This position of the balance 121 is illustrated in particular in FIG. 3.

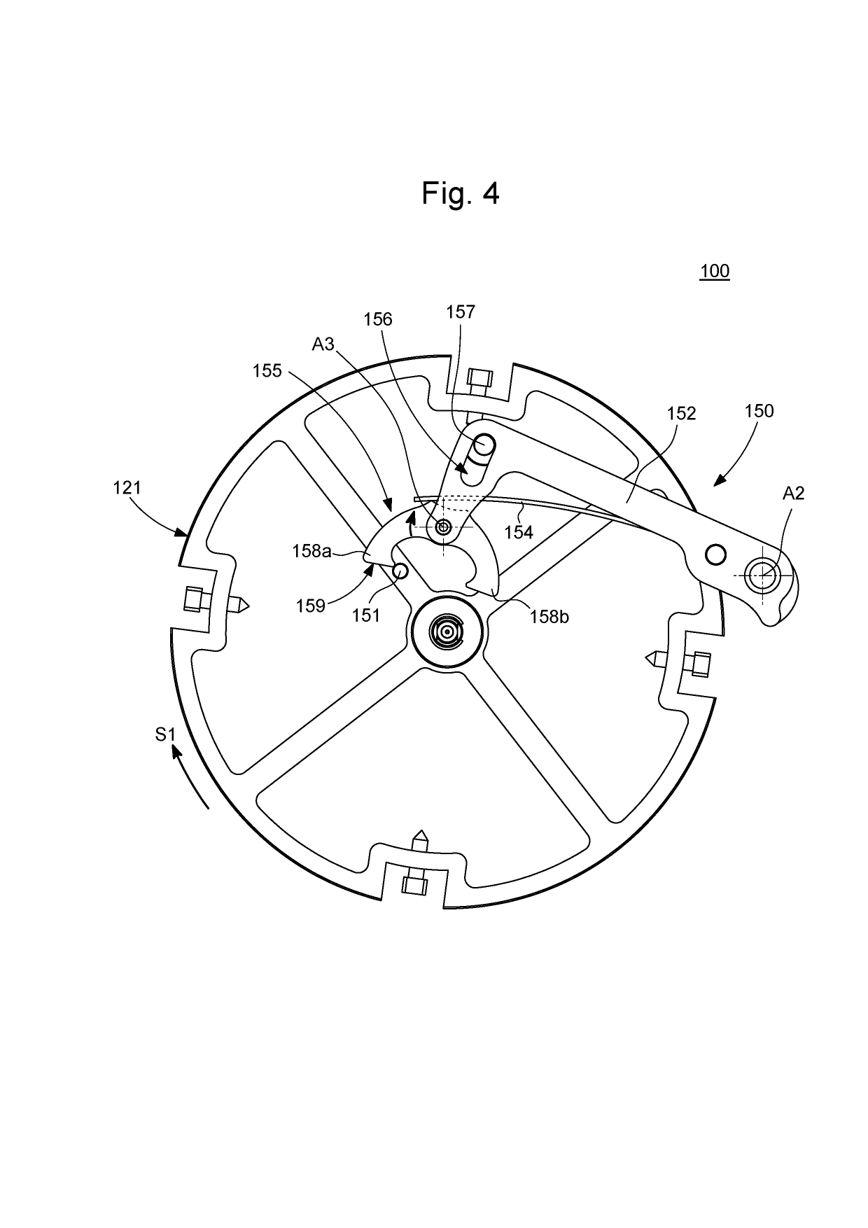

Due to the inertia of the balance 121, the retaining organ 151 will engage with the first sliding surface 159 on the beak 158a, the slope of which will cause the stop click 155 to rotate around its axis of rotation A3, overcoming the stress exerted by the click spring 154 bearing on the back of the beaks 158a, 158b, as shown in FIG. 4. FIG. 4 specifically illustrates the retaining organ 151 in contact with the end part of the first beak 158a, before it is moved to the equilibrium position.

Pivoting the stop click 155 thus allows the balance 121 to continue rotating and reach the first angular position at the end of the oscillation, as illustrated in FIG. 5.

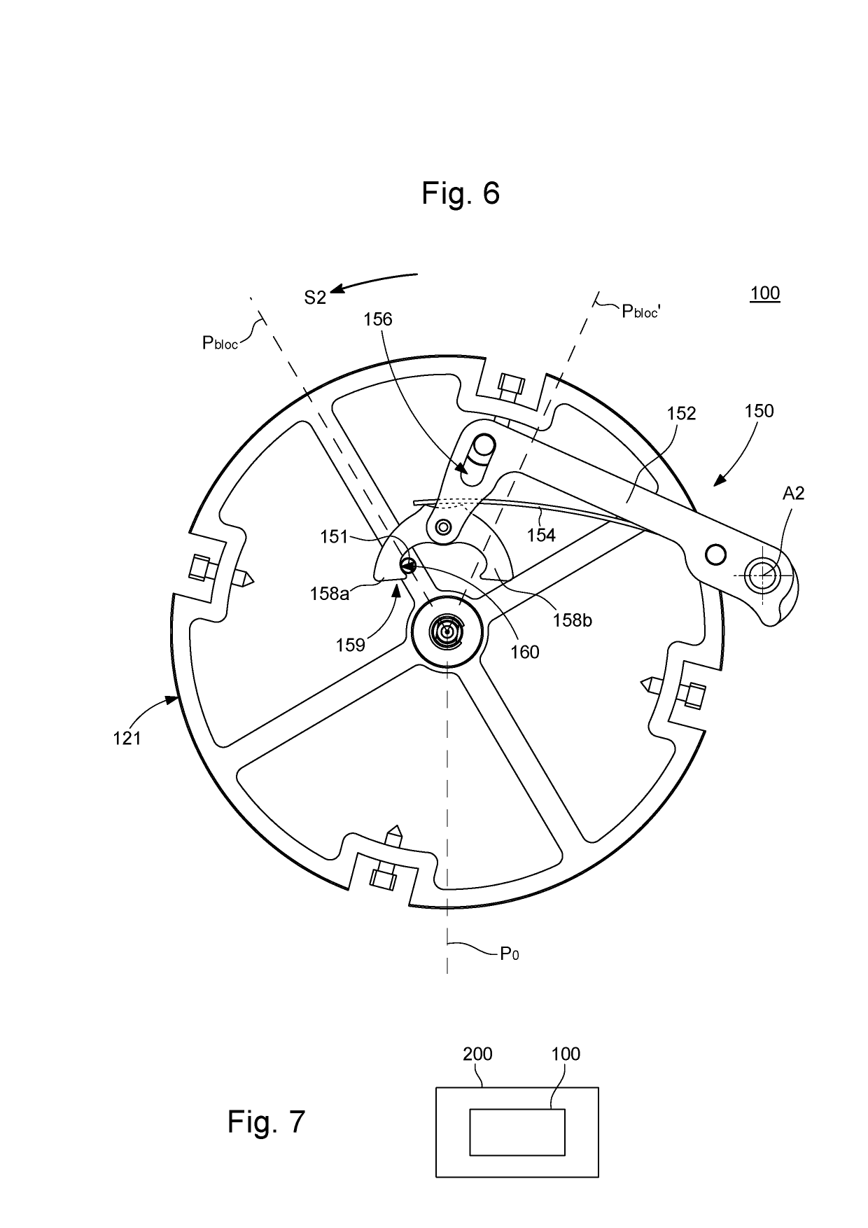

In this first angular position at the end of the oscillation of the balance 121, the balance spring 130 will tend to relax and cause the balance 121 to rotate in the reverse direction, corresponding to the counterclockwise direction S2, as illustrated in FIG. 6. At the start of this reverse rotation phase, in this case in the counterclockwise direction S2, the retaining organ 151 is locked by the stop click 155. More specifically, the retaining organ 151 will come into contact with the first stop surface 160 on the first beak 158a. The first stop surface 160 forms a lock stop, locking the retaining organ 151 and consequently the balance 121 in a first predetermined angular position Pbloc in which the balance spring 130 has a potential energy that is known and sufficient to ensure that the oscillations restart.

If the balance 121 is turning in the counterclockwise direction S2 when the stop control is activated, the balance 121 will continue its rotation around its axis of oscillation A1 in the counterclockwise direction S2 until it reaches a second angular position at the end of the oscillation before starting again in the clockwise direction S1 for the next oscillation. The first angular position at the end of oscillation when the balance 121 is oscillating in the clockwise direction S1 and the second angular position at the end of oscillation when the balance 121 is oscillating in the counterclockwise direction S2 can be identical or relatively similar to each other.

As this oscillation vibration is occurring, while the stop click 155 is on the path of the retaining organ 151, it will come into contact with the second sliding surface 159, at a distal portion of the end part of the second beak 158b.

Due to the inertia of the balance 121, the retaining organ 151 will engage with the second sliding surface 159 on the second beak 158b, the slope of which will cause the stop click 155 to rotate around its axis of rotation, in a reverse rotation relative to the direction of rotation described above, overcoming the stress exerted by the click spring 154 bearing on the back of the beaks 158a, 158b.

Pivoting the stop click 155 thus allows the balance 121 to continue rotating and reach the second angular position at the end of the oscillation of the balance 121.

In this second angular position at the end of the oscillation of the balance 121, the balance spring 130 will tend to contract and cause the balance 121 to rotate in a reverse direction, corresponding to the clockwise direction S1.

At the start of this reverse rotation phase, in this case in the clockwise direction S1, the retaining organ 151 is locked by the stop click 155. More specifically, the retaining organ 151 will come into contact with the second stop surface 160 on the second beak 158b. The second stop surface 160 forms a lock stop, locking the retaining organ 151 and the balance 121 in a second predetermined angular position Pbloc' in which the balance spring 130 has a known potential energy sufficient to ensure that the oscillations restart.

The invention makes it possible to stop the balance 121 in at least one predetermined angular position Pbloc, Pbloc' in which the balance spring 130 has a potential energy that is known and sufficient regardless of the oscillation vibration of the mechanical oscillator 120.

Of course, the stop click 155 can comprise only one beak 158a, 158b to stop the balance 121 in a single angular position Pbloc, Pbloc' among the ones described above.

To unlock the mechanical oscillator 120 under the action of the stop control or when it is returned to the reference position, the stop lever 152 is returned to its inactive position and releases the retaining organ 151 and thereby the balance 121, which is then free to oscillate.

Such a regulating system 100 is particularly suitable for use with a direct impulse escapement, for example a natural escapement, or with an escapement that does not automatically restart the balance after a stop. However, the regulating system 100 can be used with any type of escapement.

The regulating system according to the invention, and more specifically the stop device, enables the balance to be stopped in a predetermined angular position with sufficient energy to ensure autonomous restarting of the oscillations after a stop. The regulating system according to the invention also makes it possible to avoid any unintentional movements that can occur with the stop devices in the prior art when the balance is stopped. This prevents any disruption to the normal running of the components constituting the escapement and the regulating system.

The invention also relates to a horology movement 200 comprising a regulating system 100 according to the invention.

Preferentially, the horology movement 200 comprises a regulating system 100 according to the invention with a direct impulse escapement, such as a natural escapement.

1. A regulating system for a horology movement comprising:
a mechanical oscillator, oscillating around an axis of oscillation, comprising a balance coupled to a spring, each oscillation of said mechanical oscillator consisting of two successive vibrations characterised by the rotation of the balance in two successive and opposite directions of rotation;
a stop device on the mechanical oscillator configured to lock the balance in a predetermined angular position for each of the two vibrations of the mechanical oscillator, in which the spring has non-zero potential energy;
wherein the stop device comprises a retaining organ, secured to the balance, configured to engage with a stop click mounted so as to rotate freely at one end of a stop lever, said stop lever being mobile between an inactive position allowing free oscillation of the mechanical oscillator and an activated position in which the stop click is on the path of the retaining organ,
said stop click being configured so that, when the stop lever is in the activated position, the stop click allows the retaining organ to move in the direction of rotation of the current vibration of the balance, when the stop device is activated, and to lock the rotation in the reverse direction of rotation of the balance in the next vibration, said stop click forming a stop to the movement of the retaining organ.

2. The regulating system for a horology movement according to claim 1, wherein the stop click is kept in an equilibrium position by a stop spring.

3. The regulating system for a horology movement according to claim 2, wherein the stop click comprises a first beak formed by the junction of a first sliding surface and of a first stop surface, the first sliding surface being configured so as to ensure, on contact with the retaining organ, that the stop click is rotated against the stop spring, so as to allow the movement of the retaining organ in a first direction of rotation of the balance, the first stop surface being configured to form a stop to the movement of the retaining organ and to lock the rotation of the balance in a second direction of rotation, opposite to the first direction of rotation of the balance.

4. The regulating system for a horology movement according to claim 3, wherein the stop click comprises a second beak formed by the junction of a second sliding surface and of a second stop surface, the second sliding surface being configured so as to ensure, on contact with the retaining organ, that the stop click is rotated against the stop spring , so as to allow the movement of the retaining organ in the second direction of rotation of the balance, the second stop surface being configured to form a stop to the movement of the retaining organ and to lock the rotation of the balance in the first direction of rotation.

5. The regulating system for a horology movement according to claim 1, wherein the first beak and the second beak are positioned opposite and symmetrically to each other relative to a plane running through the axis of rotation of the stop click and through the axis of oscillation of the mechanical oscillator.

6. The regulating system for a horology movement according to claim 5, wherein the stop click has a C-shape in which the two ends of the C carry the first beak and the second beak.

7. The regulating system for a horology movement according to claim 1, wherein the stop device is configured to lock the balance in a predetermined angular position with an angular lag comprised between 120° and 180° relative to an angular lock position of the balance in which the balance has zero potential energy.

8. The regulating system for a horology movement according to claim 1, wherein the stop device is configured to lock the balance in a predetermined angular position with an angular lag comprised between 130° and 180° relative to an angular lock position of the balance in which the balance has zero potential energy.

9. The regulating system for a horology movement according to claim 1, wherein the stop device is configured to lock the balance in a predetermined angular position with an angular lag comprised between 140° and 180° relative to an angular lock position of the balance in which the balance has zero potential energy.

10. The regulating system for a horology movement according to claim 1, wherein the stop device is configured to lock the balance in a predetermined angular position with an angular lag comprised between 150° and 180° relative to an angular lock position of the balance in which the balance has zero potential energy.

11. The regulating system for a horology movement according to claim 1, wherein the balance comprises a felloe attached to a central part by arms, the retaining organ being positioned at the level of one of the arms or at the level of the felloe.

12. The regulating system for a horology movement according to claim 1, wherein the retaining organ is made in one piece with the balance or is formed by a pin, a peg or a stud driven in on the balance.

13. A horology movement comprising the regulating system according to claim 1.

14. The horology movement according to claim 13, further comprising a direct impulse escapement associated with the regulating system.

15. The horology movement according to claim 14, wherein the direct impulse escapement is a natural escapement.
